(19) United States
(12) Patent Application Publication
(10) Pub. No.: US 2010/0172808 A1
(43) Pub. Date: Jul. 8, 2010

(54) ION GENERATOR

(75) Inventor: Tsukasa Igarashi, Tokyo (JP)

Correspondence Address: MCCORMICK, PAULDING & HUBER LLP, CITY PLACE II, 185 ASYLUM STREET, HARTFORD, CT, 06103, US

(73) Assignee: Koganei Corporation, Tokyo (JP)

(21) Appl. No.: 12/303,564

(22) PCT Filed: Jun. 28, 2006
(86) PCT No.: PCT/JP2006/312873

§ 371 Date: Dec. 5, 2008

(30) Foreign Application Priority Data
Jun. 7, 2006 (JP) 2006-158072

(51) Int. Cl. B01J 19/08

(52) U.S. Cl. 422/186.04

(57) ABSTRACT

An ion generator can generate clean ionized gas, in which no foreign matters are mixed, and apply the same to a treated object.

Ultraviolet rays from an ultraviolet generating source 15 are irradiated to a photo receiver 11a provided with a coating layer 14 made of titanium oxide, and air surrounding the photo receiver is electrically separated to generate positively charged particles and negatively charged particles. An electric field is created by the electrode 17 in a space containing the electrically separated air to ionize the charged particles. The ionized charged particles are blown toward the treated object W by a blower 20.

### TECHNICAL FIELD

The present invention relates to an ion generator, which blows ionized gas to a treated object and processes the treated object.

### BACKGROUND ART

When electronic parts such as semiconductor chips are manufactured or assembled, if static electricity occurs to the electronic parts or in jigs used for manufacturing or assembling the electronic parts, manufacturing or assembling work of the electronic parts cannot be performed smoothly. Therefore, by using an ion generator called an “ionizer”, ionized air has been blown to members whose electricity is required to be removed. Charges can be neutralized by supplying the ionized air to each surface of the charged members.

As described in Patent Document 1, a conventional ion generator has a discharge electrode, wherein a corona discharge is caused via air by applying AC voltage to the discharge electrode, and oxygen in air is ionized by an electric field of the corona discharge.

### Patent Document 1: Japanese Patent Application Laid-Open Publication No. 2003-243199

### DISCLOSURE OF THE INVENTION

### Problems to be Solved by the Invention

However, in the ion generator constituted so as to use the discharge electrode to ionize air by the corona discharge, there are limits to enlargement of an area where a discharge phenomenon is generated, so that it is necessary to provide a plurality of discharge electrodes in order to generate a large amount of ionized air. Also, there is some fear that foreign matters, i.e., particles occur from the discharge electrode by the corona discharge, and may adhere to the treated object. When the foreign matters adhere to the treated object, working yield of the treated object lowers.

An object of the present invention is to provide an ion generator, which can generate clean ionized gas in which no foreign matters are mixed.

### Means to be Solved by the Invention

An ion generator according to the present invention comprises: an ultraviolet generating source irradiating ultraviolet rays to a photo receiver, whose surface has a metal-oxide semiconductor such as titanium oxide, and electrically separating gas surrounding the photo receiver to generate positively charged particles and negatively charged particles; an electrode connected to a power source, and creating an electric field in a space containing the electrically separated gas to ionize the charged particles; and blowing means blowing ions to a treated object.

The ion generator according to the present invention is such that the power source is an AC power source, and plus ions are produced by a plus electric field formed by the electrode while minus ions are produced by a minus electric field formed by the electrode.

The ion generator according to the present invention is such that the power source is a DC power source, the ion generator includes a positive electrode connected to a plus-side terminal of the power source and a negative electrode connected to a minus-side terminal thereof, and plus ions are produced by a plus electric field formed by the positive electrode while minus ions are produced by a minus electric field formed by the negative electrode.

The ion generator according to the present invention is such that a coating layer of a metal-oxide semiconductor is formed on a surface of a sheet-like base member, which is made of a conductive material and has through-holes, the photo receiver and the electrode are formed by the base member, and the ions are supplied to the treated object by the gas blown to the treated object through the through-holes.

The ion generator according to the present invention is such that a coating layer of a metal-oxide semiconductor is formed on a surface of a sheet-like photo receiver having through-holes, the electrode is disposed adjacently to the photo receiver, and the ions are supplied to the treated object by the gas blown to the treated object through the through-holes.

The ion generator according to the present invention is such that the electrode is disposed so as to be exposed to airflow along a surface formed on the photo receiver by a coating layer of the metal-oxide semiconductor.

The ion generator according to the present invention is such that the photo receiver is formed of an ultraviolet permeation material, and the ultraviolet rays pass through the photo receiver and are irradiated from the ultraviolet generating source to the metal-oxide semiconductor.

The ion generator according to the present invention further comprises: a first photo receiver, which is formed of an ultraviolet permeation material and whose surface is provided with a coating layer of a transparent metal-oxide semiconductor; and a second photo receiver, whose surface is provided with a coating layer of a metal-oxide semiconductor and to which ultraviolet rays which have passed through the first photo receiver are irradiated.

The ion generator according to the present invention is such that an electrode made of a transparent material is attached on a surface of the first photo receiver.

The ion generator according to the present invention further comprises: a first photo receiver, in which a coating layer of a metal-oxide semiconductor is formed on a surface of a sheet-like base member having through-holes; and a plate-like second photo receiver, on whose surface a coating layer of a metal-oxide semiconductor is formed, which is disposed via a gas-passage space so as to opposite the first photo receiver, and to which the ultraviolet rays which have passed through the through-holes of the first photo receiver are irradiated, wherein the first and second photo receivers are used as electrodes, respectively.

The ion generator according to the present invention further comprises: a first photo receiver, in which a coating layer of a metal-oxide semiconductor is formed on a surface of a sheet-like base member having through-holes; and a second photo receiver, in which a coating layer of a metal-oxide semiconductor is formed on a surface of a sheet-like base member having through-holes and which is disposed via a gas-passage space so as to oppose the first photo receiver, wherein the first and second photo receivers are used as electrodes, respectively.

### EFFECTS OF THE INVENTION

According to the present invention, since the ultraviolet rays are irradiated to the metal-oxide semiconductor such as titanium oxide to ionize gas to plasma and to ionize it by the electric field, no foreign matters are mixed in the ionized gas, so that the clean ionized gas can be generated. Since gas is electrically ionized to plasma by the ultraviolet rays, a region of the photo receiver, to which the ultraviolet rays are irradiated, can be made a plane, so that ionization can be achieved over a broad range, and a large amount of ionized air can be generated.

### BRIEF DESCRIPTION OF THE DRAWINGS

FIG. 1 is a schematic diagram showing a basic structure of an ion generator according to an embodiment of the present invention;

FIG. 2 is a schematic diagram showing a basic structure of an ion generator according to another embodiment of the present invention;

FIG. 3 is a schematic diagram showing a basic structure of an ion generator according to another embodiment of the present invention;

FIG. 4 is a schematic diagram showing a basic structure of an ion generator according to another embodiment of the present invention;

FIG. 5 is a schematic diagram showing a basic structure of an ion generator according to another embodiment of the present invention;

FIG. 6 is a schematic diagram showing basic structure of an ion generator according to another embodiment of the present invention;

FIG. 7 is a schematic diagram showing a basic structure of an ion generator according to another embodiment of the present invention;

FIG. 8 is a schematic diagram showing a basic structure of an ion generator according to another embodiment of the present invention; and

FIG. 9 is a schematic diagram showing a basic structure of an ion generator according to another embodiment of the present invention.

### BEST MODE FOR CARRYING OUT THE INVENTION

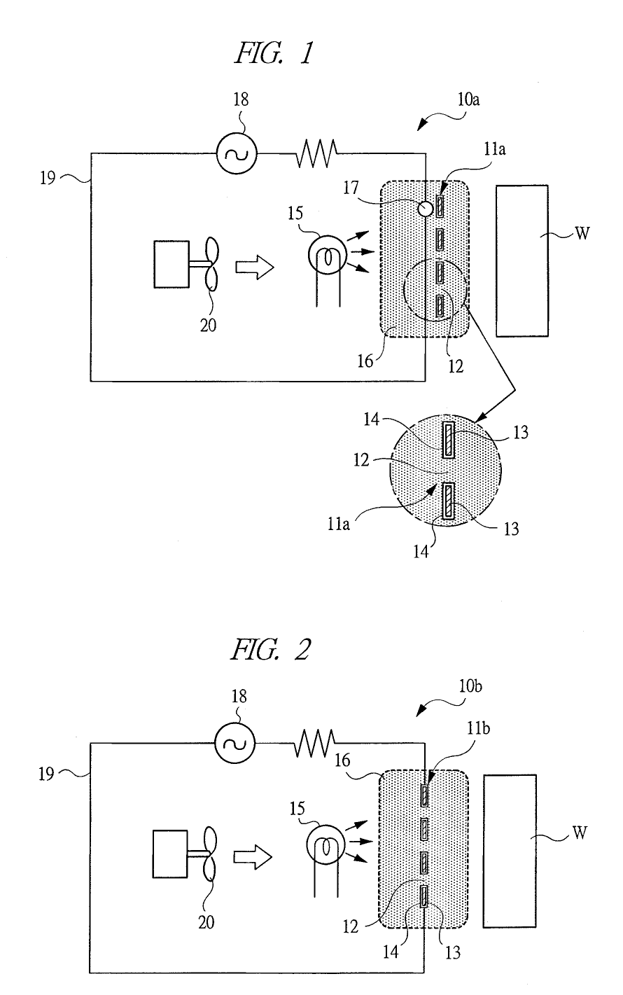

Hereinafter, embodiments of the present invention will be described in detail with reference to the drawings. FIGS. 1 to 9 are schematic diagrams showing basic structures of ion generators according to embodiments of the present invention, respectively, and the same reference numerals are denoted to members having common functions in these Figures.

An ion generator 10a shown in FIG. 1 has a photo receiver 11a. The photo receiver 11a comprises a sheet-like or mesh-like base member 13, which is made of a metal net material and has a large number of through-holes 12, wherein a coating layer 14 of titanium oxide (TiO2) is formed on a surface of the base member 13. In order to form the coating layer 14 of titanium oxide on the surface of the sheet-like base member 13, the coating layer 14 of titanium oxide can be generated on the surface of the base member 13 by using the base member 13 as an anode in electrolyte to cause a current to flow. Instead of forming of the coating layer 14 by such anode oxidation, the coating layer 14 may be formed on the surface of the base member 13 by a vacuum plating technique such as vacuum deposition or sputtering. The photo receiver 11a itself may be formed of ceramics of titanium oxide.

Light including an ultraviolet wavelength of 400 nm or less is irradiated onto a surface of the photo receiver 11a from an ultraviolet generating source 15, and an ultraviolet LED is used as the ultraviolet generating source 15. However, another ultraviolet generating source such as black light may be used as the ultraviolet generating source 15 instead of the ultraviolet LED. When ultraviolet rays are irradiated toward the coating layer 14 of titanium oxide which is a metal-oxide semiconductor, the titanium oxide reacts to the ultraviolet rays and is excited. When the titanium oxide is excited, air surrounding the photo receiver 11a is electrically separated to generate ions, namely, positively charged particles and electrons, namely, negatively charged particles and will serve as plasma 16. In FIG. 1, the plasma 16 is shown in a dotted manner.

In a case shown by Figure, titanium oxide is used as the metal-oxide semiconductor excited by the ultraviolet rays, but another metal-oxide semiconductor such as iron oxide, tungsten oxide, zinc oxide, or strontium titanate may be used instead of titanium oxide.

In order to create an electric field in a region of air that has been electrically separated to form the plasma 16, a wire-like electrode 17 is disposed, and an AC high voltage is supplied from a power source 18 to the electrode 17 via a current feeding cable 19. When the plus electric field is applied to the electrode 17, the electrons, namely, negatively charged particles in the plasma 16 are attracted to the electrode 17 by a Coulomb's force and are neutralized, and the positively charged particles in the plasma 16 are emitted into an outer space so as to be separated from the electrode 17 by the Coulomb's force due to reaction on the electric field, thereby being coupled to other atoms or molecules in air to form plus ions.

Meanwhile, when the minus electric field is applied to the electrode 17, the positively charged particles in the plasma 16 are attracted to the electrode by the Coulomb's force due to reaction on the electric field to be taken in the electrode 17, and are neutralized by reaction with the supplied electrons, while the electrons in the plasma 16 are emitted to the outer space by the Coulomb's force due to reaction on the electric field so as to be separated from the electrode 17, and further are taken in air molecules to form minus ions.

In order to blow, toward a treated object W, the ions emitted to the outer space, the ion generator 10a has a blower 20, and the blower 20 opposes the photo receiver 11a so that air blown from the blower 20 passes through the through-holes 12 to be blown to the treated object W. Thereby, the plus ions and minus ions are blown to the treated object W, so that even if the treated object W is charged by static electricity, the static electricity is neutralized.

Since ultraviolet rays are irradiated to the photo receiver 11a to electrically separate and then ionize air, as compared with such a case that air is ionized by a corona discharge, occurrence of particles can be prevented during ionization. Forming the photo receiver 11a into a sheet shape can cause a large amount of ionized air to be generated within a range of an area broader than using a needle-like electrode to generate a corona discharge.

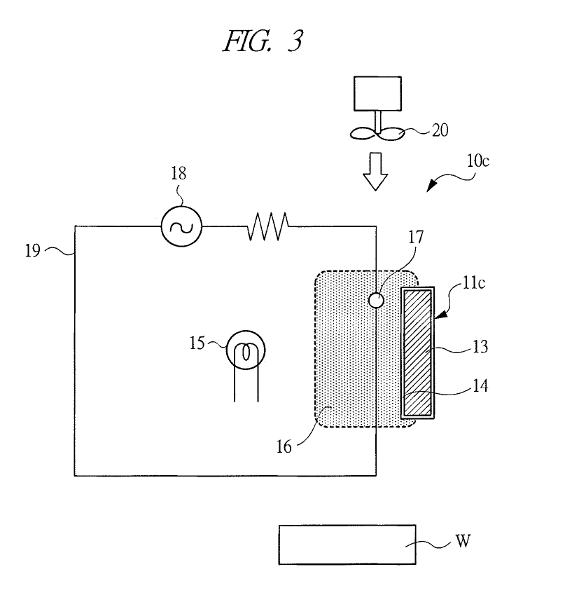

In an ion generator 10b shown in FIG. 2, the base member 13 of a photo receiver 11b serves also as an electrode, and when light including an ultraviolet wavelength of 400 nm or less is irradiated from the ultraviolet generating source 15 toward the coating layer 14 of titanium oxide, the titanium oxide reacts with the ultraviolet rays and is excited. When the titanium oxide is excited, air surrounding the photo receiver 11b is electrically separated to generate positively charged particles and negatively charged particles and to become the plasma 16. Further, when power is applied from the power source 18 to the base member 13 made of a conductive material and when the blower 20 is driven, similarly to the case shown in FIG. 1, the plus ions and minus ions are blown to the treated object W, so that even if the treated object W is charged by the static electricity, the static electricity is neutralized. Thus, if the sheet-like photo receiver 10b is intended to serve also as the electrode, the ions can be efficiently emitted.

In an ion generator 10c shown in FIG. 3, a photo receiver 11c is formed into a plate shape, and the coating layer 14 of titanium oxide is provided on the surface of the plate-like base member 13. Airflow is supplied from the blower 20 along the surface of the photo receiver 11c, and the electrode 17 is disposed so as to be exposed to the airflow. Also in the ion generator 10c, as described above, the plus ions and minus ions can be blown to the treated object W, and air from the blower 20 can be blown to the treated object W with a resistance force smaller than a case where it is blown by passing through the through-holes 12.

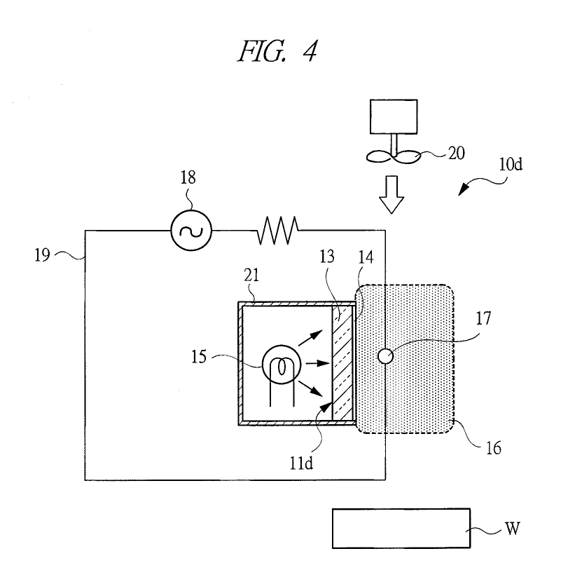

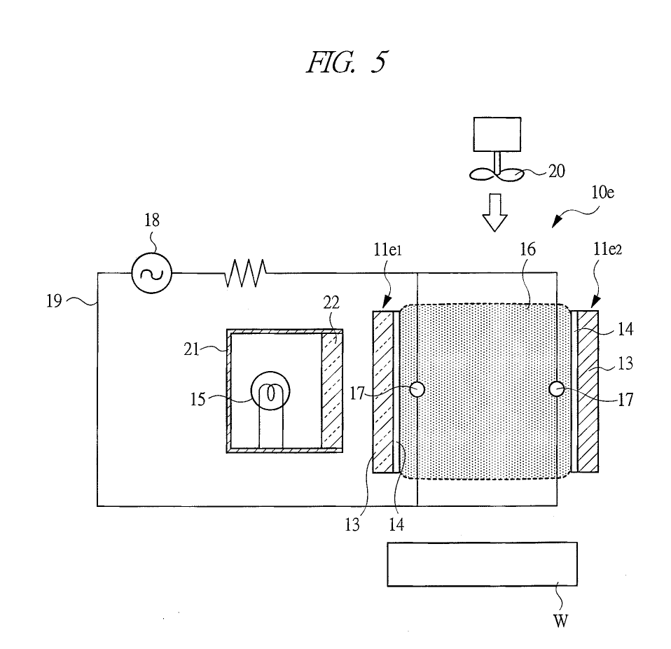

In an ion generator 10d shown in FIG. 4, the ultraviolet generating source 15 is accommodated in a container 21, and a plate-like photo receiver 11d is attached to the container 21. The base member 13 of the photo receiver 11d is formed of an ultraviolet permeation material, and the coating layer 14 of titanium oxide is provided on an outer surface of the base member 13. Thus, when the ultraviolet generating source 15 is intended to be assembled in the container 21, adhesion of dusts to the ultraviolet generating source 15 can be prevented.

An ion generator 10e shown in FIG. 5 has the container 21 accommodating the ultraviolet generating source 15, similarly to the ion generator 10d shown in FIG. 4, wherein a lid member 22 made of an ultraviolet permeation material is attached to the container 21. A photo receiver 11e1 is disposed as a first photo receiver so as to opposite the lid member 22, and for the photo receiver 11e1, similarly to the photo receiver 11d, the coating layer 14 of titanium oxide is provided on the surface of the base member 13 made of an ultraviolet permeation material.

A photo receiver 11e2 is disposed as a second photo receiver via a space so as to opposite the photo receiver 11e1, and in the photo receiver 11e2, the coating layer 14 of titanium oxide is provided on a surface of a plate-like base member made of ceramics of titanium oxide. The coating layer 14 of titanium oxide has a transparence, and light including ultraviolet wavelengths from the ultraviolet generating source 15 passes through the lid member 22, the photo receiver 11e1, and the coating layer 14 of the photo receiver 11e1 to be irradiated to the coating layer 14 of the photo receiver 11e2.

Air exhausting from the blower 20 is supplied in a space between the two photo receivers 11e1 and 11e2 to form airflow. The two electrodes 17 are arranged so as to be exposed to the airflow. Accordingly, for the two photo receivers 11e1 and 11e2, electric fields are formed, in a space containing the electrically separated air, by both the electrodes due to power applied from the power source 18.

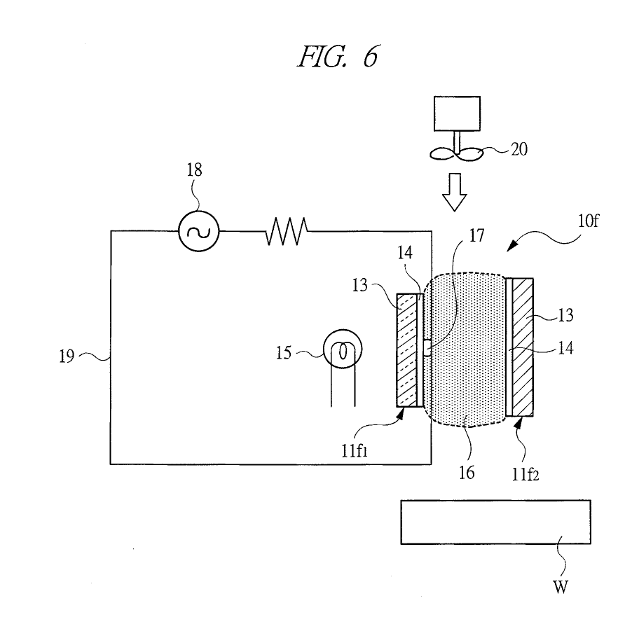

In an ion generator 10f shown in FIG. 6, the electrode 17 is provided on the coating layer 14 provided on a surface of a photo receiver 11f1. If the electrode 17 is made of titanium oxide similarly to the coating layer 14, the coating layer 14 and the electrode can be formed integrally. A photo receiver 11f2 serving as a second photo receiver correspondingly to a photo receiver 11f1 serving as a first photo receiver is disposed via a space so as to opposite the photo receiver 11f1, and the coating layer 14 is provided on a surface of the photo receiver 11f2. By using, as the photo receiver 11f2, the same structure as that of the photo receiver 11f1, the ion generator having the two electrodes 17 correspondingly to the respective photo receivers similarly to the case shown in FIG. 5 can be achieved.

Also in the ion generator 10f of this type, the ultraviolet generating source 15 may be accommodated in a container similarly to the ion generators shown in FIGS. 4 and 5, and also in the ion generators shown in FIGS. 1 and 2, the ultraviolet generating source 15 may be accommodated in a container.

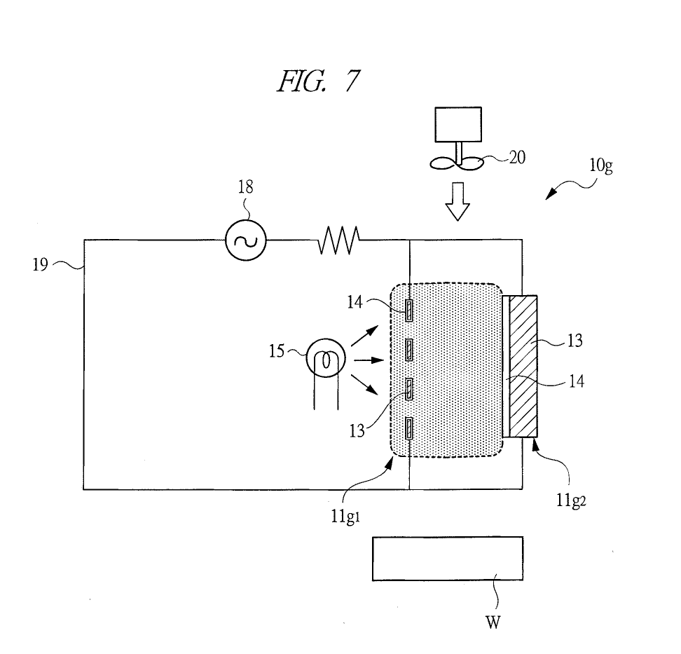

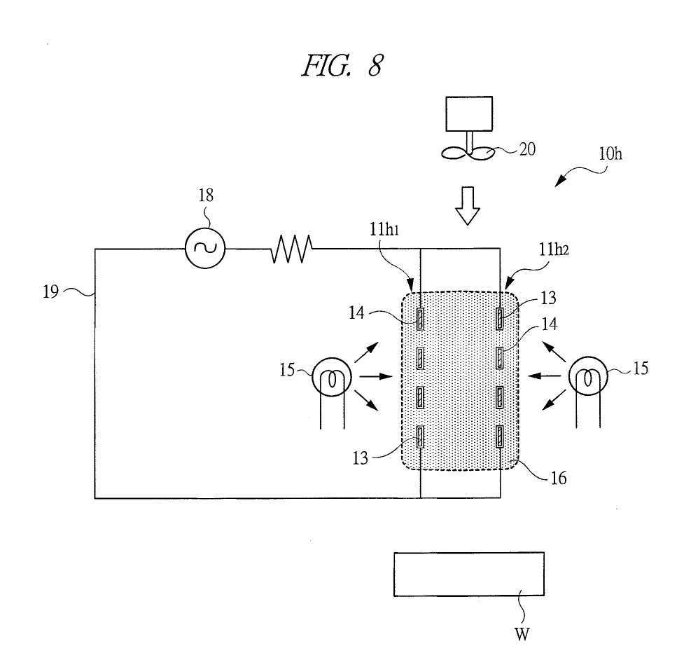

An ion generator 10g shown in FIG. 7 has, similarly to the ion generator 10b shown in FIG. 2, a photo receiver 11g1 serving also as an electrode, and a photo receiver 11g2 serving also as an electrode, and both the photo receivers 11g1 and 11g2 become parallel to each other via a space. In the photo receiver 11g2, the coating layer 14 of titanium oxide is provided on a surface of the flat plate-like base member, and the ultraviolet rays from the ultraviolet generating source 15 is irradiated to the coating layer 14 provided on a surface of the photo receiver 11g1 and simultaneously passes through the through-holes 12 to be irradiated to the coating layer 14 of the photo receiver 11g2.

The respective photo receivers 11g1 and 11g2 are connected to a power source 18, and electric fields are formed, in a space containing the electrically separated air, by both the electrodes due to power applied from the power source 18.

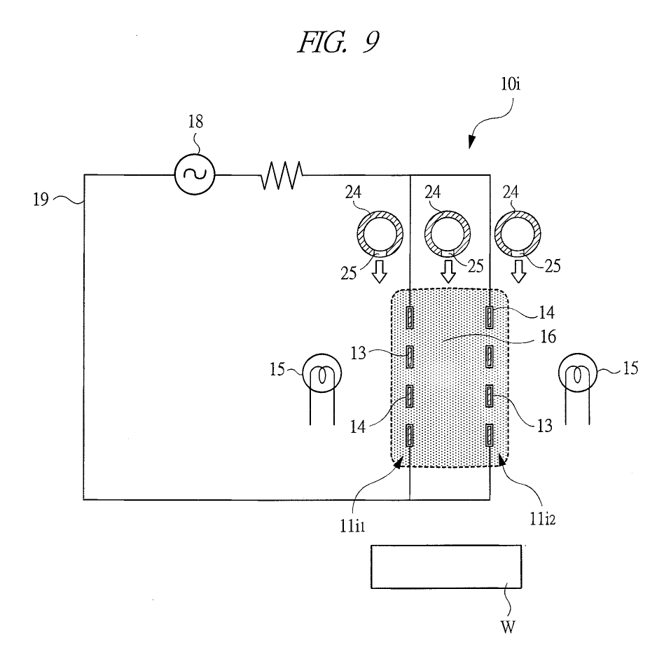

An ion generator 10h shown in FIG. 8 has, similarly to the ion generator 10b shown in FIG. 2, photo receivers 11h1 and 11h2 serving also as respective electrodes, and two ultraviolet generating sources 15 are provided correspondingly to the respective photo receivers 11h1 and 11h2.

An ion generator 10i shown in FIG. 9 is a modified example of the ion generator 10h shown in FIG. 8, and has, similarly to the ion generator 10b shown in FIG. 2, photo receivers 11i1 and 11i2 serving also as respective electrodes. The ion generator 10i has pipes 24 each supplying air instead of the blower 20 shown in FIG. 8. Jetting holes 25 for jetting air are formed in the respective pipes 24, whereby airflow blowing ions to the treated object is formed by air from the jetting holes 25.

The present invention is not limited to the above-mentioned embodiments, and may be variously modified within a scope of not departing from the gist of the invention. In the embodiments, air is intended to be ionized, but the present invention can be applied also to a case that another gas other than air is ionized.

In the embodiments described above, an alternating current is applied from the power source 18 to the electrode 17, but a direct current may be applied to the electrode 17. In that case, a positive electrode connected to a plus-side terminal of the power source and a negative electrode connected to a negative-side terminal thereof are arranged as electrodes adjacently to the photo receiver, whereby plus ions are produced by the plus electric field formed by the positive electrode, and minus ions are produced by the minus electric field formed by the negative electrode.

### INDUSTRIAL APPLICABILITY

The ion generator of the present invention is used to blow ionized air to a portion(s), whose static electricity should be removed, in a manufacturing line for performing manufacture or assembly of electromagnetic parts.

1. An ion generator comprising:
an ultraviolet generating source irradiating ultraviolet rays to a photo receiver, whose surface has a metal-oxide semiconductor such as titanium oxide, and electrically separating gas surrounding the photo receiver to generate positively charged particles and negatively charged particles;
an electrode connected to a power source, and creating an electric field in a space containing the electrically separated gas to ionize the charged particles; and
blowing means blowing ions to a treated object.

2. The ion generator according to claim 1, wherein the power source is an AC power source, and plus ions are produced by a plus electric field formed by the electrode while minus ions are produced by a minus electric field formed by the electrode.

3. The ion generator according to claim 1, wherein the power source is a DC power source, the ion generator includes a positive electrode connected to a plus-side terminal of the power source and a negative electrode connected to a minus-side terminal thereof, and plus ions are produced by a plus electric field formed by the positive electrode while minus ions are produced by a minus electric field formed by the negative electrode.

4. The ion generator according to claim 1, wherein a coating layer of a metal-oxide semiconductor is formed on a surface of a sheet-like base member, which is made of a conductive material and has through-holes, the photo receiver and the electrode are formed by the base member, and the ions are supplied to the treated object by the gas blown to the treated object through the through-holes.

5. The ion generator according to claim 1, wherein a coating layer of a metal-oxide semiconductor is formed on a surface of a sheet-like photo receiver having through-holes, the electrode is disposed adjacently to the photo receiver, and the ions are supplied to the treated object by the gas blown to the treated object through the through-holes.

6. The ion generator according to claim 1, wherein the electrode is disposed so as to be exposed to airflow along a surface formed on the photo receiver by a coating layer of the metal-oxide semiconductor.

7. The ion generator according to claim 1, wherein the photo receiver is formed of an ultraviolet permeation material, and the ultraviolet rays pass through the photo receiver and are irradiated from the ultraviolet generating source to the metal-oxide semiconductor.

8. The ion generator according to claim 1, further comprising: a first photo receiver, which is formed of an ultraviolet permeation material and whose surface is provided with a coating layer of a transparent metal-oxide semiconductor; and a second photo receiver, whose surface is provided with a coating layer of a metal-oxide semiconductor and to which ultraviolet rays which have passed through the first photo receiver are irradiated.

9. The ion generator according to claim 8, wherein an electrode made of an ultraviolet permeation material is attached on a surface of the first photo receiver.

10. The ion generator according to claim 1, further comprising: a first photo receiver, in which a coating layer of a metal-oxide semiconductor is formed on a surface of a sheet-like base member having through-holes; and a plate-like second photo receiver, on whose surface a coating layer of a metal-oxide semiconductor is formed, which is disposed via a gas-passage space so as to opposite the first photo receiver, and to which the ultraviolet rays which have passed through the through-holes of the first photo receiver are irradiated, wherein the first and second photo receivers are used as electrodes, respectively.

11. The ion generator according to claim 1, further comprising: a first photo receiver, in which a coating layer of a metal-oxide semiconductor is formed on a surface of a sheet-like base member having through-holes; and a second photo receiver, in which a coating layer of a metal-oxide semiconductor is formed on a surface of a sheet-like base member having through-holes and which is disposed via a gas-passage space so as to oppose the first photo receiver, wherein the first and second photo receivers are used as electrodes, respectively.
